(19) United States
(12) Patent Application Publication
(10) Pub. No.: US 2023/0311045 A1
(43) Pub. Date: Oct. 5, 2023

(54) FILTER ELEMENT PAPER COMPONENT AND AIR FILTER MESH

(71) Applicant: Linjun SHEN, Linli (CN)

(72) Inventor: Linjun SHEN, Linli (CN)

(21) Appl. No.: 18/329,600

(22) Filed: Jun. 6, 2023

(30) Foreign Application Priority Data
May 25, 2023 (CN) 202321286610.3

(51) Int. Cl. B01D 46/00; B01D 46/52; B01D 46/88; B01D 39/20; B01D 46/58

(52) U.S. Cl. CPC B01D 46/0016; B01D 39/2055; B01D 46/0005; B01D 46/0036; B01D 46/521; B01D 46/58; B01D 46/88; B01D 2265/05; B01D 2267/30; B01D 2277/30

(57) ABSTRACT

The present disclosure discloses a filter element paper component, including two frames, wherein the two frames are oppositely arranged and are not connected; filter element paper, wherein two ends of the filter element paper are fixedly connected to the corresponding frames respectively, and the two frames separately locate the two ends of the filter paper during mounting; and a separation strip, detachably connected between the two frames to form a complete hollow cavity. The filter paper is folded and arranged in the cavity. The separation strip is pulled to be respectively separated from the two frames, and the two frames arranged at the two ends of the filter element paper are separately pulled to unfold the filter element paper.

### TECHNICAL FIELD

The present disclosure relates to the technical field of air filter meshes, particularly to a filter element paper component and an air filter mesh.

### BACKGROUND

Existing fresh air filter meshes usually adopt paper or a metal outer frame. Most of the fresh air filter meshes are overall scrapped when filter element paper materials expire, or old filter element paper materials are replaced with the help of tools. The existing air filter meshes are transported after filter paper and shells are assembled. This takes up a large volume, causes high transportation costs, and wastes a storage space. Furthermore, according to the existing products on the market, the filter paper and the frame shell are adhered together. After the filter paper expires, the frame shell and the filter paper would be scrapped together, causing a waste of resources and significant environmental pollution.

Patent No. CN215388275U provides a convenient-to-assemble split type air filter, including an upper cover and a base which are detachably connected. The upper cover includes an upper cover body, and an upper cover edge side plate and an upper cover end side plate which are arranged on one side of the upper cover body. The upper cover body is provided with a hollow portion. The base includes a base body, and a base edge side plate and a base end side plate which are arranged on one side of the base body. The base body is provided with a hollow portion. Several fixed bulges are arranged on an outer side of the upper cover edge side plate and an outer side of the upper cover end side plate. Fixed grooves corresponding to the fixed bulges are formed in an inner side of the base edge side plate and an inner side of the base end side plate. The upper cover and the base are fixed by using the fixed bulges and the fixed grooves, making it easy to disassemble the split type air filter and replace filter paper. Although the filter paper can be replaced through the detachable connection between the upper cover and the base, two sides of the filter paper need to be clamped between the upper cover and the base, so that it is relatively complex to mount the filter paper. Therefore, a filter element paper component and an air filter mesh are provided to solve the problems that filter element paper in the air filter mesh in the prior art is inconvenient to replace and easily deforms during transportation.

### SUMMARY

One objective of the present disclosure provides a filter element paper component and an air filter mesh, so as to solve the problems that filter element paper in an air filter mesh in the prior art is inconvenient to replace and easily deforms during transportation.

A filter element paper component and an air filter mesh of the present disclosure can be achieved by the following technical solutions:

A filter element paper component of the present disclosure includes two frames, wherein the two frames are oppositely arranged and are not connected; filter element paper, wherein two ends of the filter element paper are fixedly connected to the corresponding frames respectively, and the two frames separately locate the two ends of the filter paper during mounting; and a separation strip, detachably connected between the two frames to form a complete hollow cavity. The filter paper is folded and arranged in the cavity. The separation strip is pulled to be respectively separated from the two frames, and the two frames arranged at the two ends of the filter element paper are separately pulled to unfold the filter element paper.

In one implementation, a material of each frame is an organic polymer material or an inorganic material.

In one implementation, the filter element paper adopts folding filter paper, which is convenient for folding and transportation of the filter paper.

In one implementation, an activated carbon layer is arranged in the filter element paper; and the activated carbon layer effectively absorbs harmful substances in air.

In one implementation, the two ends of the filter paper are respectively adhered to the two frames through glue or pins, or in a folding manner, so that fixed connection between the filter element paper and the two frames is facilitated.

In one implementation, the separation strip includes a separation strip main body and at least one gap; the separation strip main body is connected to the two frames respectively through tear-and-pull lines; and the at least one gap is formed in the separation strip main body, facilitating tearing the separation strip main body from the two frames along the tear-and-pull lines.

In one implementation, a material of the separation strip main body is an organic polymer material or an inorganic material.

In one implementation, the two frames and the separation strip main body are integrally formed, so that the two frames and the separation strip main body form a hollow cavity in a folding manner.

In one implementation, the cavity is a square cavity, a cylindrical cavity, a lid and base cavity, or a dual-plug cavity.

In one implementation, the two gaps are symmetrically formed in two ends of the separation strip main body respectively, facilitating a user to randomly pull the separation strip main body from both a front surface and a back surface.

In one implementation, a sealing strip covers each gap; and the sealing strip is attached to any frame or the separation strip main body.

An air filter mesh includes a plurality of the above-mentioned filter element paper components, wherein the plurality of filter element paper components are arranged in an air filter mesh main body side by side.

Compared with the prior art, the filter element paper component and the air filter mesh of the present disclosure have beneficial effects:

According to the filter element paper component and the air filter mesh of the present disclosure, the separation strip is pulled to be separated from the two frames, thereby unfolding the filter element paper arranged between the two frames. The filter element paper is mounted in the air filter mesh by using the locating effects of the two frames, thereby effectively solving the problems that the filter element paper in the air filter mesh in the prior art is inconvenient to replace and easily deforms during transportation.

According to the filter element paper component and the air filter mesh of the present disclosure, the hollow cavity formed by the separation strip and the two frames is used to protect the filter element paper, so that the filter element paper can be folded and arranged in the hollow cavity, which effectively reduces an occupied space and transportation costs of the filter element paper. Meanwhile, the gaps are formed in both sides of the filter element paper component, so that it is convenient for a user to pull the separation strip through any gap, which improves the user experience to a certain extent.

### BRIEF DESCRIPTION OF THE DRAWINGS

In order to explain the technical solutions of the embodiments of the present disclosure more clearly, the following will briefly introduce the accompanying drawings used in the embodiments. It should be understood that the drawings in the following description only illustrate some embodiments of the present disclosure and thus shall not be deemed as limiting the scope. Those of ordinary skill in the art can obtain other related drawings based on these drawings without creative work.

FIG. 1 is a schematic diagram of a three-dimensional structure of a filter element paper component of the present disclosure;

FIG. 2 is a schematic structural diagram of the filter element paper component of the present disclosure shown in FIG. 1 in another view;

FIG. 3 is a structural exploded diagram of the filter element paper component of the present disclosure shown in FIG. 1 in another view;

FIG. 4 is a schematic diagram of a three-dimensional structure of a filter element paper component of the present disclosure in a first use state;

FIG. 5 is a schematic structural diagram of the filter element paper component of the present disclosure shown in FIG. 4 in the first use state in another view; and

FIG. 6 is a schematic diagram of a three-dimensional structure of a filter element paper component of the present disclosure in a second use state.

Numerals in the drawings: 11: first frame; 12: second frame; 13: filter element paper; 14: separation strip; 141: separation strip main body; and 142: gap.

### DETAILED DESCRIPTION OF THE EMBODIMENTS

In order to make the objectives, technical solutions and advantages of the embodiments of the present disclosure clearer, the technical solutions in the embodiments of the present disclosure will be described clearly and completely below in combination with the drawings in the embodiments of the present disclosure. Obviously, the embodiments described herein are part of the embodiments of the present disclosure, not all the embodiments. The components of the embodiments of the present disclosure generally described and shown in the drawings here can be arranged and designed in a variety of different configurations.

Therefore, the following detailed description for the embodiments of the present disclosure provided in the accompanying drawings is not intended to limit the scope of the claimed present disclosure, but merely represents selected embodiments of the present disclosure. All other embodiments obtained by those of ordinary skill in the art based on the embodiments in the present disclosure without creative work shall fall within the protection scope of the present disclosure.

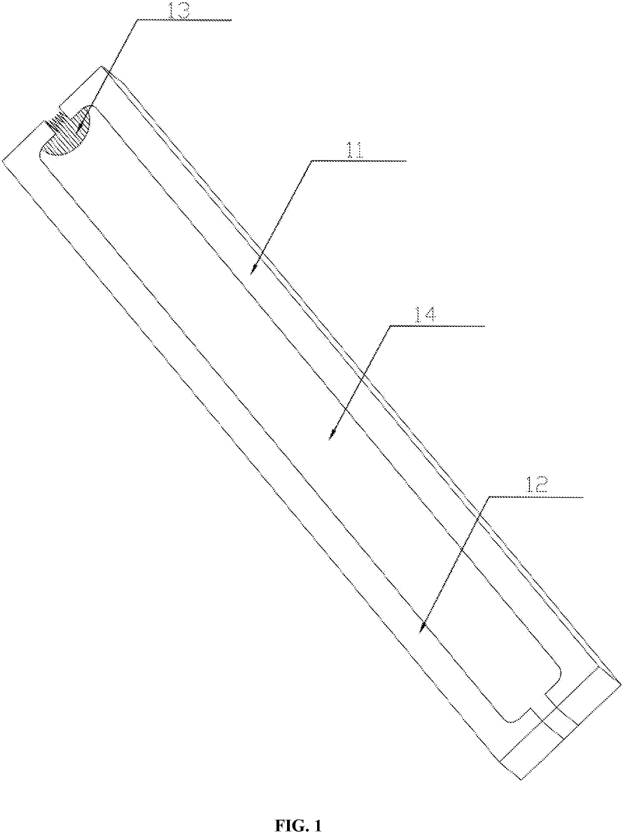

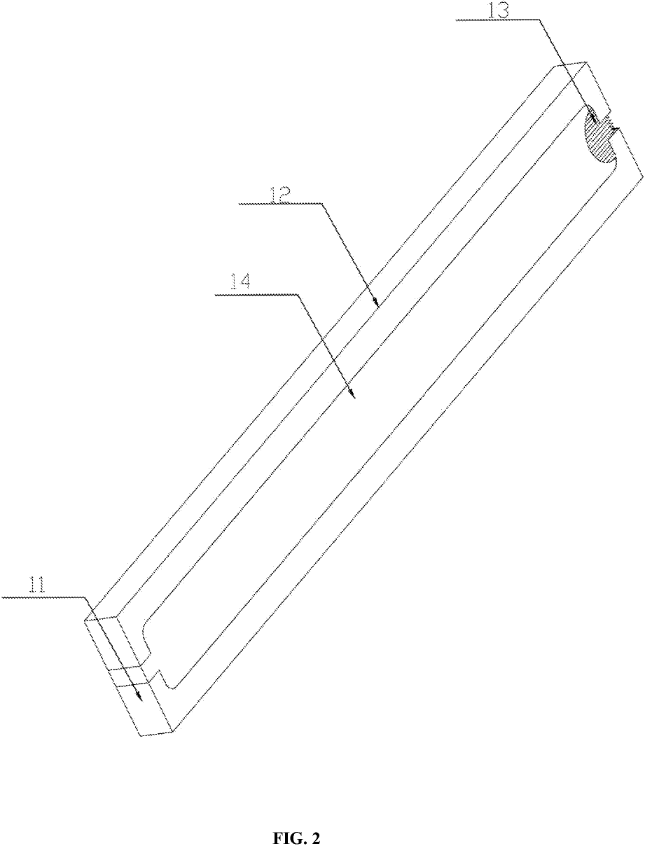

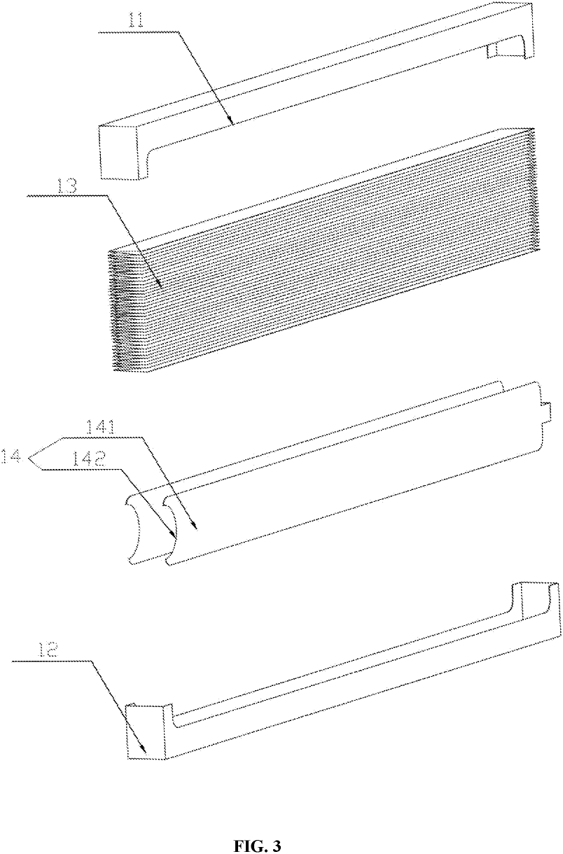

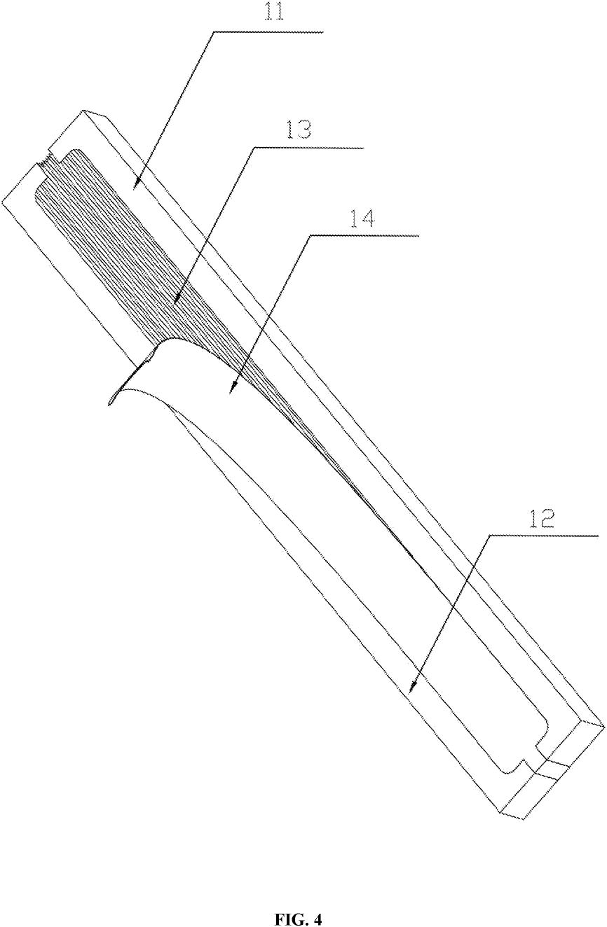

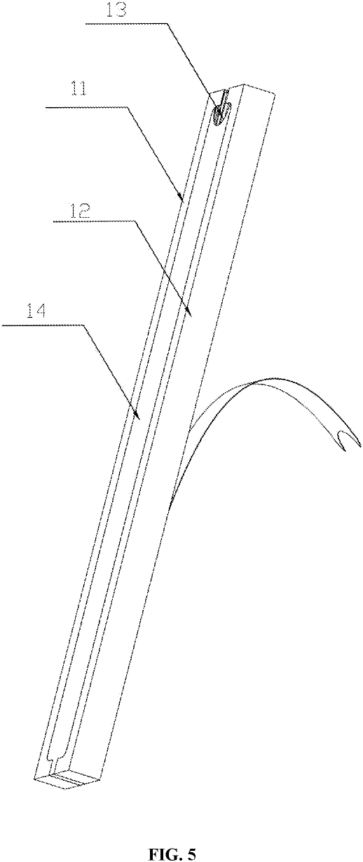

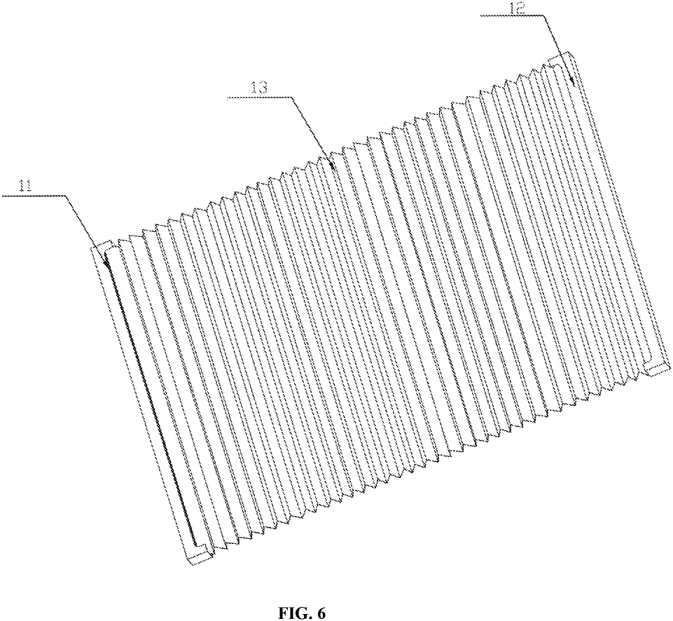

Referring to FIG. 1 to FIG. 6, the filter element paper component of the present disclosure may include a first frame 11, a second frame 12, filter element paper 13, and a separation strip 14. The first frame 11 and the second frame 12 are oppositely arranged and are not connected, and are separately used for locating two ends of the filter element paper 13 during mounting. One end of the filter element paper 13 is fixedly connected to the first frame 11, and the other end is fixedly connected to the second frame 12. The separation strip 14 is detachably connected between the first frame 11 and the second frame 12 to form a complete hollow cavity. The filter element paper 13 is folded and arranged in the cavity. This design reduces a space occupied by the filter element paper 13, facilitates the transportation of the filter element paper component, and protects the filter element paper 13 arranged inside. The separation strip 14 is pulled to be simultaneously separated from the first frame 11 and the second frame 12, and the first frame 11 and the second frame 12 arranged at the two ends of the filter element paper 13 are respectively pulled to unfold the filter element paper.

Referring to FIG. 1 to FIG. 6, a material of the first frame 11 and the second frame 12 is an organic polymer material or an inorganic material. Specifically, the material of the first frame 11 and the second frame 12 is paper, wood, or plastic. In this embodiment, as the filter component is a disposable product, from the perspective of the costs and environmental protection, the material of the first frame 11 and the second frame 12 is paper. In this embodiment, the filter element paper 13 is folding filter paper. This design facilitates the folding and transportation of the filter element paper 13. Preferably, an activated carbon layer is arranged in the filter element paper 13. The activated carbon layer can effectively absorb harmful substances, such as formaldehyde and xylene, in air. The two ends of the filter element paper 13 are adhered to the first frame 11 and the second frame 12 through glue or pins, or in a folding manner.

Referring to FIG. 1 to FIG. 5, in this embodiment, the separation strip 14 includes a separation strip main body 141 and at least one gap 142. The separation strip main body 141 is connected to the first frame 11 and the second frame 12 respectively through tear-and-pull lines. The at least one gap 142 is formed in the separation strip main body 141, and the user puts a finger into one of the gaps 142 to facilitate tearing the separation strip main body 141 from the position between the first frame 11 and the second frame 12 along the tear-and-pull lines, thereby separating the separation strip 14 from the first frame 11 and the second frame 12 respectively, facilitating the unfolding and use of the filter element paper 13. In other embodiments, other separation manners can also be used to separate the separation strip 14 from the first frame 11 and the second frame 12, respectively. A material of the separation strip main body 141 is an organic polymer material or an inorganic material. Specifically, the material of the separation strip main body 141 is paper, wood, or plastic. In this embodiment, the material of the separation strip main body 141 is paper. This design facilitates integrated formation of the first frame 11, the second frame 12, and the separation strip main body 141, and reduces the production costs. By means of folding, the first frame 11, the second frame 12, and the separation strip main body 141 form a hollow cavity. The cavity can be a square cavity, a cylindrical cavity, a lid and base cavity, a dual-plug cavity, or a cavity in another shape. Specifically, the cavity is a square cavity. In this embodiment, the two gaps 142 are symmetrically formed in two ends of the separation strip main body 141 respectively, facilitating a user to randomly pull the separation strip main body 141 from both a front surface and a back surface. In other embodiments, in order to achieve the sealing performance of the cavity enclosed by the first frame 11, the second frame 12, and the separation strip main body 141, a sealing strip covers each gap 142. The sealing strip can be attached to the first frame 11, the second frame 12, or the separation strip main body 141. During use, the sealing strips are first torn off from the corresponding gaps 142. Then, the separation strip 14 is started to be pulled through the corresponding gaps 142, so that the separation strip 14 is separated from the first frame 11 and the second frame 12 simultaneously, thereby facilitating unfolding and use of the filter element paper 13.

An air filter mesh includes a plurality of the filter element paper components mentioned above. The plurality of filter element paper components are arranged in an air filter mesh main body side by side. This design facilitates joint transportation of the plurality of filter element paper components and the air filter mesh main body, and reduces the occupied space and the transportation costs.

It should be noted that a use process of the filter element paper component and the air filter mesh of the present disclosure is as follows: The separation strip 14 is pulled to be separated from the first frame 11 and the second frame 12 respectively; the first frame 11 and the second frame 12 are pulled with both hands; the filter element paper 13 folded between the first frame 11 and the second frame 12 are unfolded towards both sides, and then the unfolded combination of the first frame 11, the second frame 12, and the filter element paper 13 is put into the appropriate air filter mesh main body, and the first frame 11 and the second frame 12 are respectively placed in corresponding fixed grooves in the air filter mesh main body; and it is ensured whether the combination is completely placed.

The technical features of the embodiments described above can be arbitrarily combined. In order to make the description concise, all possible combinations of various technical features in the above embodiments are not completely described. However, the combinations of these technical features should be considered as the scope described in this specification as long as there is no contradiction in them.

The above-mentioned embodiments only express several implementation modes of the present disclosure, and their descriptions are more specific and detailed, but they cannot be understood as limiting the patent scope of the present disclosure. It should be noted that those of ordinary skill in the art can further make various transformations and improvements without departing from the concept of the present disclosure, and these transformations and improvements all fall within the protection scope of the present disclosure. Therefore, the protection scope of the patent of the present disclosure shall be subject to the appended claims.

What is claimed is:

1. A filter element paper component, comprising two frames, wherein the two frames are oppositely arranged and are not connected;
filter element paper, wherein two ends of the filter element paper are fixedly connected to the corresponding frames respectively, and the two frames separately locate the two ends of the filter paper during mounting; and
a separation strip, detachably connected between the two frames to form a complete hollow cavity, wherein the filter paper is folded and arranged in the cavity; the separation strip is pulled to be respectively separated from the two frames; and the two frames arranged at the two ends of the filter element paper are separately pulled to unfold the filter element paper.

2. The filter element paper component according to claim 1, wherein a material of each frame is an organic polymer material or an inorganic material.

3. The filter element paper component according to claim 1, wherein the filter element paper adopts folding filter paper, which is convenient for folding and transportation of the filter paper.

4. The filter element paper component according to claim 3, wherein an activated carbon layer is arranged in the filter element paper; and the activated carbon layer effectively absorbs harmful substances in air.

5. The filter element paper component according to claim 3, wherein the two ends of the filter paper are respectively adhered to the two frames through glue or pins, or in a folding manner, so that fixed connection between the filter element paper and the two frames is facilitated.

6. The filter element paper component according to claim 1, wherein the separation strip comprises a separation strip main body and at least one gap; the separation strip main body is detachably connected to the two frames respectively through tear-and-pull lines; and the at least one gap is formed in the separation strip main body, facilitating tearing the separation strip main body from the two frames along the tear-and-pull lines.

7. The filter element paper component according to claim 6, wherein a material of the separation strip main body is an organic polymer material or an inorganic material.

8. The filter element paper component according to claim 7, wherein the two frames and the separation strip main body are integrally formed, so that the two frames and the separation strip main body form a hollow cavity in a folding manner.

9. The filter element paper component according to claim 8, wherein the cavity is a square cavity, a cylindrical cavity, a lid and base cavity, or a dual-plug cavity.

10. The filter element paper component according to claim 6, wherein the two gaps are symmetrically formed in two ends of the separation strip main body respectively, facilitating a user to randomly pull the separation strip main body from both a front surface and a back surface.

11. The filter element paper component according to claim 6, wherein a sealing strip covers each gap; and the sealing strip is attached to any frame or the separation strip main body.

12. An air filter mesh, comprising a plurality of the filter element paper components according to claim 1, wherein the plurality of filter element paper components are arranged in an air filter mesh main body side by side.
